(19) United States
(12) Patent Application Publication
(10) Pub. No.: US 2007/0228716 A1
(43) Pub. Date: Oct. 4, 2007

(54) Collapsible steering column assembly and method of operation

(76) Inventors: Ratko Menjak, Frankenmuth, MI (US); Brian J. Magnus, Frankenmuth, MI (US); Karen A. Boswell, Freeland, MI (US)

Correspondence Address: DELPHI TECHNOLOGIES, INC., M/C 480-410-202, PO BOX 5052, TROY, MI, 48007, US

(21) Appl. No.: 11/709,627

(22) Filed: Feb. 22, 2007

Related U.S. Application Data
(60) Provisional application No. 60/788,209, filed on Mar. 31, 2006.

(51) Int. Cl. B62D 1/00

(52) U.S. Cl. 280/777

(57) ABSTRACT

A collapsible steering column assembly preferably has a collapsible steering shaft that extends rotatably along a centerline and a collapsible column that houses and co-extends with the shaft. The column preferably has inner and outer jackets that retract axially to collapse the column. An energy absorbing device has an elongated strap having a substantially linear first segment engaged to the inner jacket and a substantially linear second segment engaged to the outer jacket. The first and second segments preferably project in a common axial direction from a bend segment of the strap having a pre-defined radius. At least a portion of the strap is in a preferably converging recess that extends axially with the column. The recess is preferably defined by the outer jacket and is configured to accept the bend segment. During column collapse and thus plastic deformation of the strap, the radius of the bend segment preferably decreases as the bend segment generally scrolls along the length of the strap.

### CROSS-REFERENCE TO RELATED APPLICATIONS

The present application claims priority and all advantages of U.S. Provisional Patent Application Ser. No. 60/788,209 filed on Mar. 31, 2006.

### BACKGROUND OF THE INVENTION

1. Field of the Invention

This application relates generally to steering columns, and more particularly to adaptive energy absorbing devices for collapsible steering columns and a method of operation.

2. Description of Related Art

Automotive steering columns are typically equipped with kinetic energy absorption devices to reduce injury of a vehicle operator in the event of a collision that may cause the operator to impact the steering wheel. Such impacts during vehicle collision typically cause the steering column to collapse thereby absorbing energy that may otherwise be transmitted to the operator.

Such energy absorbing steering columns generally include a housing that translates linearly through a collapse stroke during a collision. A force generated by the driver from an impact with the steering wheel initiates the collapse stroke. The steering wheel housing moves against a resisting or reactive force that may be produced by an energy absorber designed to convert a portion of the driver's kinetic energy into work. The resisting force may be generated utilizing systems currently known in the art, including the plastic deformation of a metal element that is a part of an energy absorbing device.

Such energy absorbing (E/A) devices presently have fixed energy absorption capabilities, and offer no control over their performance during the collapse stroke. Typically, the resisting force against which the column is stroked is provided by plastic deformation of a metal element which comprises a part of the E/A system.

Generally, traditional energy absorbing devices have a fixed energy absorbing curve which is optimized to protect a given group of drivers, in most cases represented by an average size male driver. To better protect other groups of drivers not belonging to the average male driver group, such as smaller female drivers or large drivers, an adjustable energy absorbing device is needed in the art. It is also desirable for E/A devices to have performance characteristics that can vary upon factors other than driver size, such as his or her position and the speed of vehicle.

It is, therefore, desirable for an energy absorbing device to be adjustable based upon a given driver size and his position, as well as include variables for the severity of the collision. It is also desirable to use an energy absorbing device that is capable of adjusting in a time frame similar to that of an airbag system. Therefore, to account for the severity of the collision, and act at the same time as an airbag, an energy absorbing device should be capable of adjustment within a few milliseconds of time such that a given load curve can be utilized by the device based on the severity of the collision and the characteristics of the driver.

There is, therefore, a need in the art for an active energy absorbing device that is capable of automatically adjusting performance characteristics to account for the severity of a collision, as well as the characteristics of the driver; and to do so within a workable time span (i.e. a few milliseconds) and similar to that of an airbag deployment.

### SUMMARY OF THE INVENTION

A collapsible steering column assembly preferably has a collapsible steering shaft that extends rotatably along a centerline and a collapsible column that houses and co-extends with the shaft. The column preferably has inner and outer jackets that retract axially to collapse the column. An energy absorbing (E/A) device has an elongated strap having a substantially linear first segment engaged to the inner jacket and a substantially linear second segment engaged to the outer jacket. The first and second segments preferably project in a common axial direction from a bend segment of the strap having a pre-defined radius. At least a portion of the strap is in a preferably converging recess that extends axially with the column. The recess is preferably defined by the outer jacket and is configured to accept the bend segment. During column collapse and thus plastic deformation of the strap, the radius of the bend segment preferably decreases as the bend segment generally scrolls along the length of the strap. This radius decrease is predetermined and depends upon the desired load curve.

The strap may also have two or more layers with each layer having an arcuate portion comprising the bend segment in their totality. Moreover, the strap may be a loop having two opposing bend segments.

The present invention provides an E/A device that exerts a resistance along collapse stroke using a single strap device. In accordance with the present invention, the device undergoes deformation in two or three different ways. The present invention provides the ability to match energy absorption to load curves of different shapes during collapse of the column. The present invention achieves this result preferably with a single, one piece strap that deforms without friction to ensure a stable energy absorption process with maximum simplicity and low cost.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a partial perspective view of a collapsible steering column assembly of the present invention;

FIG. 2 is a cross section of the collapsible steering column assembly taken along line 2-2 of FIG. 1;

FIG. 3 is a perspective view of a single layered strap of an E/A device of the collapsible steering column assembly;

FIG. 4 is a partial perspective view of a second embodiment of a collapsible steering column assembly illustrating an E/A device;

FIG. 5 is a cross section of the collapsible steering column assembly taken along line 5-5 of FIG. 4;

FIG. 6 is a partial cross section of a third embodiment of a collapsible steering column assembly illustrating an E/A device; and

FIG. 7 is a partial cross section of a fourth embodiment of a collapsible steering column assembly illustrating an E/A device.

Corresponding reference characters indicate corresponding parts throughout the several views. Although the drawings represent embodiments of the present invention, the drawings are not necessarily to scale and certain features may be exaggerated or simplified in order to better illustrate and explain the present invention. The exemplifications set out herein illustrate embodiments of the invention in several forms, and such exemplifications are not to be construed as limiting the scope of the invention in any manner.

### DETAILED DESCRIPTION OF THE INVENTION

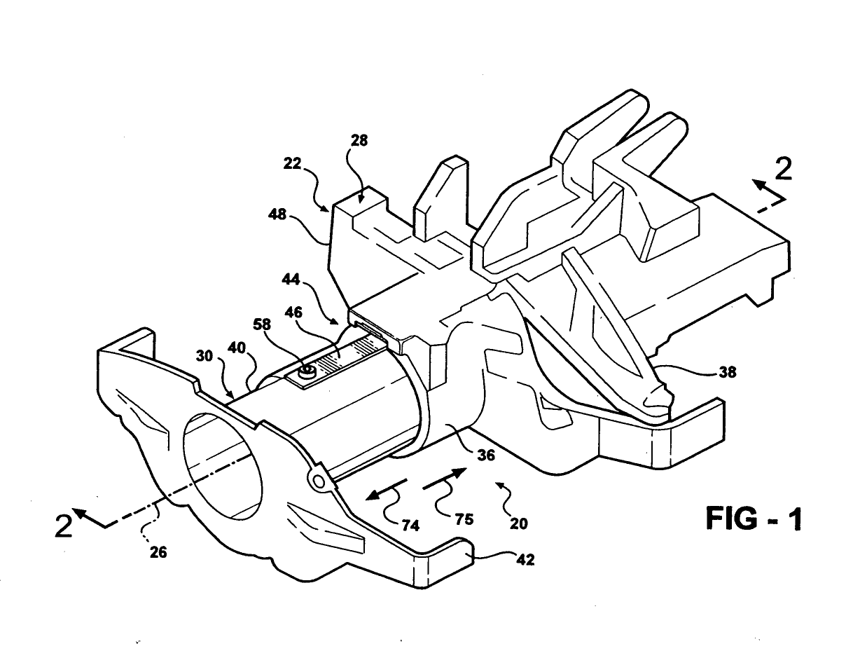

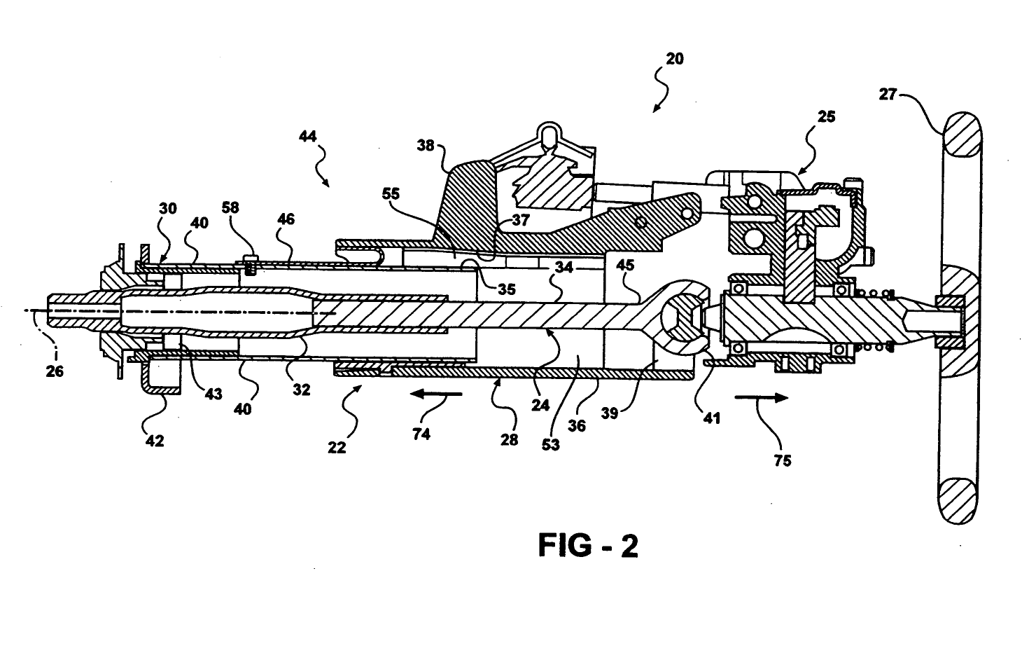

Referring to FIGS. 1-2, a steering column assembly 20 exemplifying the present invention includes an outer longitudinally collapsible column 22, a telescopically collapsible steering shaft 24 and preferably a steering wheel tilt mechanism 25 engaged to a steering wheel 27. The column 22 and the shaft 24 extend longitudinally along a centerline 26 with the shaft 24 located radially inward from and generally concentric to the column 22. The collapsible column 22 has a radially outward jacket 28, and a radially inward jacket 30. The collapsible steering shaft 24 of the assembly 20 has forward and rearward portions 32, 34 engaged telescopically to one-another and generally extending through the jackets 28, 30. The forward portion 32 projects outward from the inner jacket 30 and in a forward direction, with respect to the vehicle, and the rearward portion 34 projects in a rearward direction for pivotal engagement to the tilt mechanism and thus engagement to the steering wheel 27.

Preferably, the shaft portions 32, 34 are configured to one another along the centerline 26 allowing limited longitudinal or axial movement there-between for adjustment of steering wheel position (not shown). Whether the steering wheel position is adjustable or not during normal operation, the shaft portions 32, 34 are preferably constructed and arranged to collapse telescopically during a vehicle collision. During normal operation of the vehicle the column 22 is generally rigid. However, during a collision the rearward portion 34 of steering shaft 24 moves in a substantially forward direction 74 and telescopically into the forward portion 32. During this movement, the rearward shaft portion 34 also moves axially with respect to jacket 28 that may remain secured to the vehicle chassis.

Preferably, the outer jacket 28 is a unitary casting that integrates an outer tube or tubular portion 36 for receipt of the shaft 24 and a bracket portion 38 for releasable engagement to a vehicle chassis and generally tilt-and-lock engagement to the tilt mechanism 25. The bracket portion 38 of outer jacket 28 preferably secures to the vehicle structure through capsules (not shown) fitted into the bracket portion 38 and designed to break away therefrom during column collapse. The tubular portion 36 preferably carries a journal or socket 39 for substantially frictionless support of a universal joint 41 at a rearward end 45 of the shaft portion 34 that generally engages the tiltable steering wheel 27. The journal 39, and as known in the art, is constructed and arranged to permit substantially frictionless rotation of the shaft 24 with respect to tubular portion 36 while preferably allowing at least partial axial collapse of the steering shaft 24 without collapse of the column 22. That is, the shaft portion 34 may move axially with respect to the tubular portion 36 at least for a portion of its total axial collapse travel before the column 22 begins to collapse. However, one skilled in the art would now know that the column 22 may collapse simultaneously with the steering shaft 24 thus axial movement between the shaft portion 34 and the tubular portion 36 may not be present.

The inner jacket 30 preferably has an inner tube or tubular portion 40 and a stamped bracket portion 42 preferably welded rigidly to a distal end of the tubular portion 40. The stamped bracket portion 42 engages rigidly, and without release, to the vehicle chassis. The tubular portion 40 preferably carries a bearing ring 43 for substantially frictionless rotation of the steering shaft 24 located therein. Unlike the journal carried by the outer jacket 28, the bearing ring 43 carried by the inner jacket 30 does not generally permit axial movement between the inner jacket 30 and the forward portion 32 of shaft 24 during shaft collapse.

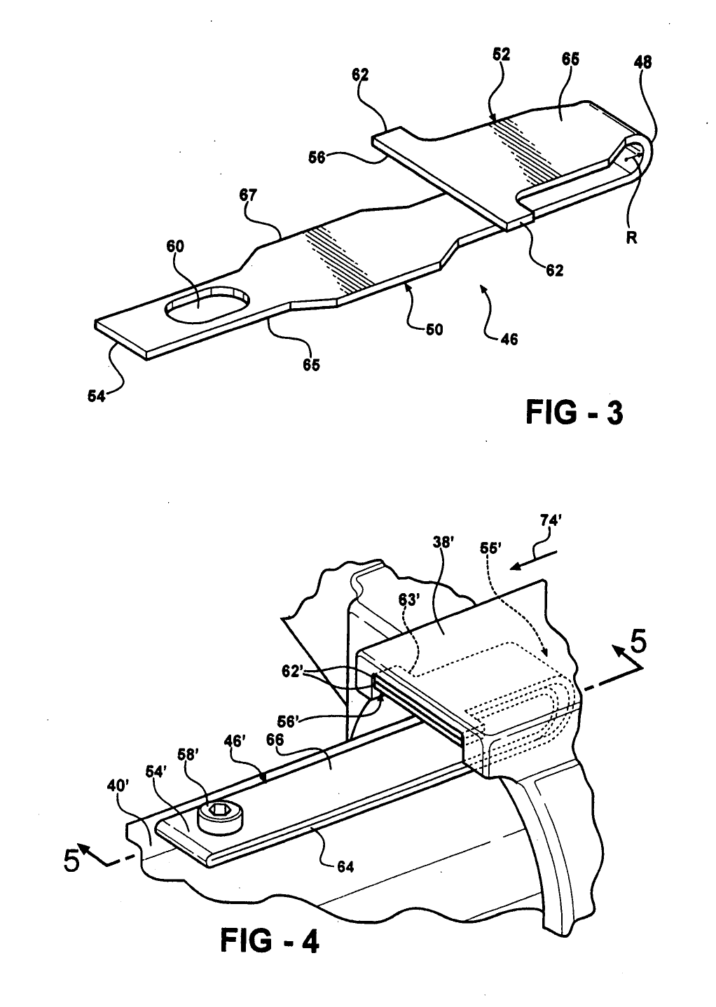

Referring to FIGS. 1-3, during normal vehicle operation, the chassis and the E/A device 44 of the assembly 20 longitudinally and steadfastly fixes the outer jacket 28 to the inner jacket 30. The E/A device 44 is operatively positioned radially between the tubular portion 40 of the inner jacket 30 and the tubular portion 36 of the outer jacket 28 and with respect to centerline 26. The E/A device 44 is capable of absorbing kinetic energy at a non-linear rate with respect to the column collapse stroke and generally matches a pre-determined load curve.

The E/A device 44 has at least one strap 46, a recess 55 that converges in the axial rearward direction 75, and a fastener 58. Preferably, the strap 46 is formed from a single strip of a plastically-deformable material such as steel. The strap 46 is preferably bent over or is bent approximately one-hundred and eighty degrees at a first bend segment 48 having a radius (R). Substantially linear first and second segments 50, 52 of the strap 46 project axially along the centerline 26 from the respective ends of the bend segment 48 and in the forward direction 74. Prior to column collapse, the first and second segments 50, 52 are spaced radially apart from one-another, with respect to the centerline 26, by a distance approximately equal to twice the distance of the radius (R) of the bend segment 48. The first segment 50 projects from the bend segment 48 to a first end 54, and the second segment 52 projects from the bend segment 48 to an opposite and second end 56 of the strap 46.

Preferably, the tubular portion 40 of the inner jacket 30 is substantially cylindrical in shape and the tubular portion 36 of the outer jacket 28 defines a substantially cylindrical bore 53 for fitted receipt of the tubular portion 40. The axially extending recess 55 of the E/A device 44 is defined preferably and at least in part by a second surface 37 carried by the bracket portion 38 of the outer jacket 28, and communicates radially inward with the bore 53. As the second surface 37 extends in the rearward direction 75, the second surface 37 preferably slants radially inward by a number of degrees (α). The axial length of the recess 55 corresponds with the column stroke distance during column collapse. Because the recess 55 generally converges as it extends in the rearward direction 75, the radial space between a first surface 35 carried by the tubular portion 40 of the inner jacket 30 and the second surface 37 carried by the outer jacket 28 decreases in the rearward direction 75. The second surface 37 is preferably not planar and instead is contoured to correlate with a desired load curve. For instance, a forward portion of surface 37 may be substantially parallel to centerline 26 and a rearward portion of surface 37 may actual converge by degree (α). Preferably, the radial distance or space between the first surface 35 and the forward portion of second surface 37 is about equal to twice the radius R of the bend segment 48 prior to strap deformation. One skilled in the art would now know that the parallel configuration of the first surface 35 and the slanted configuration of the second surface 37 can be interchanged.

When the collapsible steering column assembly 20 is fully assembled and prior to collapse, the first segment 50 is substantially outside of the recess 55, and the bend segment 48 and the second segment 52 is just inside the recess 55. During assembly and because the first segment 50 is outside of the recess, 55, the fastener or threaded bolt 58 of the E/A device 44 is easily inserted through a hole 60 in the first end 54 of the strap 46 and threaded into the inner jacket 30 for rigidly securing end 54 to the inner jacket 30. The opposite second end 56 preferably has a pair of laterally projecting tabs 62 that contact a pair of corresponding, forward facing, stops 63 carried by the bracket portion 38 of the outer jacket 28. Strap segments 50, 52 both project in the axial forward direction 74 and to respective ends 54, 56. The strap 46 has a first face 65 and an opposite second face 67. The first face 65 at the first and second segments 50, 52 is generally in contact with the respective inner and outer jackets 28, 30. The second face 67 is generally convex at the bend segment 48 and opens or faces preferably in the forward direction 74.

During a collapse stroke of the steering column assembly 20, the outer jacket 28 moves in the forward direction 74, and carries the second end 56 of the strap 46 with it. Because the first end 54 of the strap 46 is secured to the stationary inner jacket 30, the strap 46 deforms plastically creating a force that generally resists, to a pre-defined limited degree, the collapse stroke. As the steering column 22 collapses telescopically, the axial length of the first segment 50 of the strap 46 shortens and the length of the second segment 52 lengthens. In-other-words, the bend segment 48 tends to relocate and scroll along the length of the deforming strap 46. As the bend segment 48 scrolls further into the recess 55 or outer jacket 28, the radius (R) of the bend segment 48 reduces itself because the recess 55 converges as previously specified. As the radius tightens or becomes smaller, the resistive force increases.

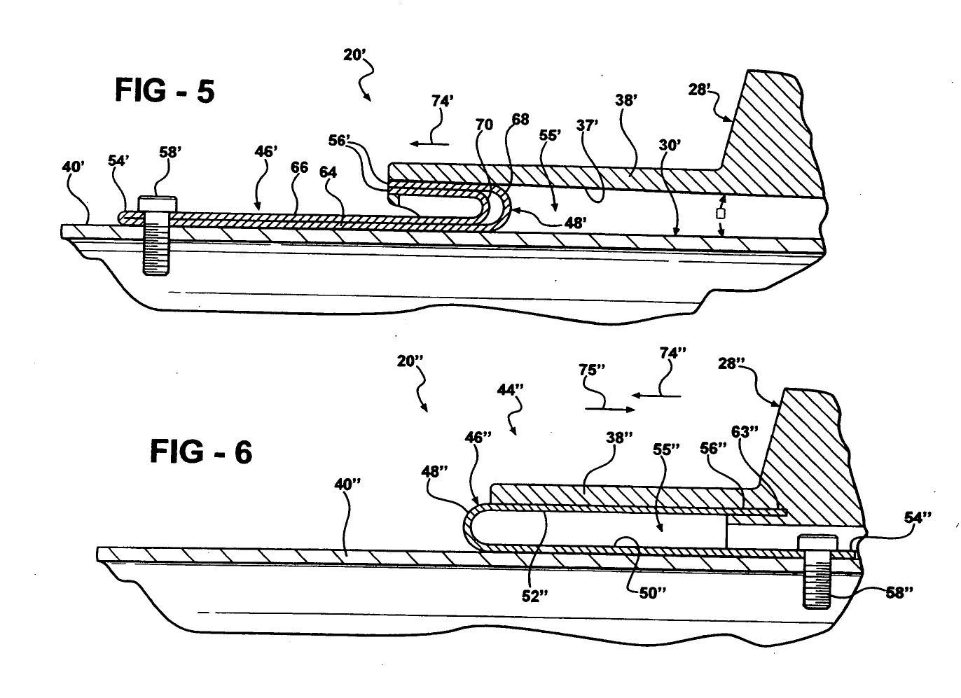

Referring to FIGS. 4 and 5, a second embodiment of a collapsible steering column assembly 20′ is illustrated wherein like elements to the first embodiment have like identifying numerals except with the addition of a prime symbol. An E/A device 44′ of assembly 20′ has a strap 46′ that is preferably folded over upon itself and generally creased at a first end 54′ forming first and second strips or layers 64 and 66. The layers 64, 66 are thus generally attached at the folded end 54′ and extend therefrom to respective distal or material free ends 56′ each preferably having tabs 62′. A bend segment 48′ of strap 46′ has an arcuate portions 68, 70 for each respective layer 64, 66. The arcuate portion 68 of layer 64 has a radius that is larger than a radius of the arcuate portion 70 of the second layer 66 by a distance substantially equal to the thickness of layer 64. In this embodiment and during column collapse, both arcuate portions 68, 70 scroll through respective layers 64, 66 as the strap 46′ deforms.

Referring to FIG. 6, a third embodiment of a collapsible steering column assembly 20″ is illustrated wherein like elements to the first embodiment have like identifying numerals except with the addition of a double prime symbol. A strap 46″ of an E/A device 44″ have substantially linear first and second segments 50″, 52″ projecting in an axial rearward direction 75″ from a bend segment 48″. Prior to column collapse, the bend segment 48″ may be located outside of a recess 55″, and the first and second segments 50″, 52″ are located inside the recess 55″. During column collapse as the outer jacket 28″ moves in the axial forward direction 74″, the bend segment 48″ scrolls along the length of the strap 46″ causing the second segment 52″ to shorten and the first segment 50″ to lengthen.

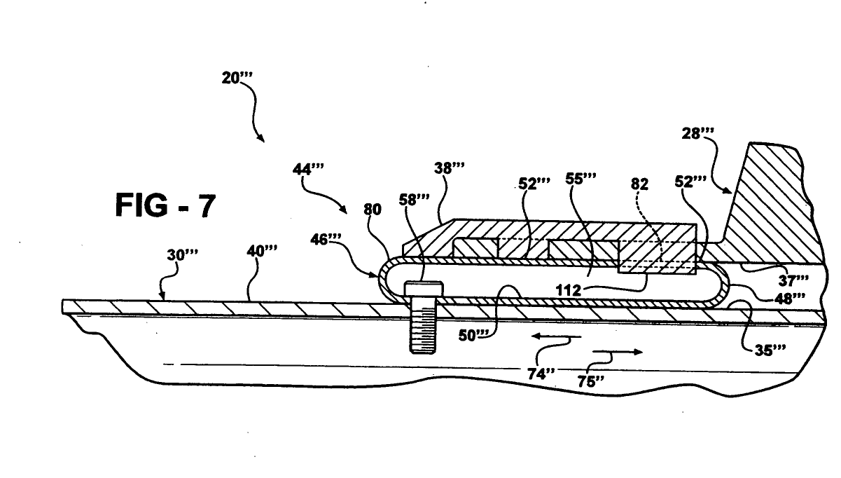

Referring to FIG. 7, a fourth embodiment of a collapsible steering column assembly 20′″ is illustrated wherein like elements have like identifying numerals except with the addition of a triple prime symbol. The assembly 20′″ has an E/A device 44′″ preferably having a strap 46′″ that generally forms a loop. The strap or loop 46′″ has a first linear segment 50′″ located adjacent to a first surface 35′″ of an inner jacket 30′″ and extending axially between a first bend segment 48′″ and an opposing second bend segment 80. The first bend segment 48′″ is cupped in a forward direction 74′″ and the second bend segment 80 is cupped in an opposite rearward direction 75′″. A linear second segment 52′″ located directly adjacent to a second surface 37′″ carried by an outer jacket 28′″ extends in the forward direction 74′″ from the first bend segment 48′″ and to the second bend segment 80 thereby completing the continuous loop. Preferably, a forward portion of the first segment 50′″ is connected to the inner jacket 30′″ near the second bend segment 80 via a fastener 58′″. A rearward portion of the second segment 52′″ is connected to a bracket portion 38′″ of the outer jacket 28′″ near the first bend segment 48′″. This connection 82 may be by any variety of ways known in the art such as a press fit to the bracket portion 38′″, a weld, or any variety of fasteners.

Although the preferred embodiments of the present invention have been disclosed, various changes and modifications may be made thereto by one skilled in the art without departing from the scope and spirit of the invention as set forth in the appended claims. For instance, the loop 46″ of the fourth embodiment may be accentuated with the double layers 64, 66 of the second embodiment. It is also understood that the terms used herein are merely descriptive, rather than limiting, and that various changes in terminology may be made without departing from the scope and spirit of the invention.

1. A collapsible steering column assembly for a vehicle comprising:
a collapsible steering shaft extending rotatably along a centerline;
inner and outer jackets co-extending with and rotatably supporting the steering shaft with the inner and outer jackets constructed and arranged to collapse axially with respect to one another;
a first surface carried by the inner jacket facing radially outward;
a second surface carried by the outer jacket facing radially inward and spaced radially outward from the first surface; and
a deformable strap bent over upon itself and having a first segment engaged to the inner jacket and axially extending adjacent to the first surface, a bend segment having a radius and orientated radially between the first and second surface, and a second segment engaged to the outer jacket and axially extending adjacent to the second surface;
wherein the strap is constructed and arranged to deform plastically during a vehicle collision when the inner and outer jackets collapse axially with respect to one another.

2. The collapsible steering column assembly set forth in claim 1 further comprising:
a second end of the strap engaged to the outer jacket; and
wherein the second segment extends axially between the second end and the bend segment.

3. The collapsible steering column assembly set forth in claim 2 further comprising:
a first end of the strap engaged to the inner jacket; and
wherein the first segment extends axially between the first end and the bend segment.

4. The collapsible steering column assembly set forth in claim 3 wherein the inner jacket is stationary and the outer jacket is constructed and arranged to move axially in a forward direction along the centerline during collapse of the column.

5. The collapsible steering column assembly set forth in claim 4 wherein the bend segment is open in the forward direction.

6. The collapsible steering column assembly set forth in claim 5 wherein the first segment is longer than the second segment prior to collapse of the steering column.

7. The collapsible steering column assembly set forth in claim 4 wherein the bend segment is open opposite to the forward direction.

8. The collapsible steering column assembly set forth in claim 7 wherein the first segment is longer than the second segment prior to collapse of the steering column.

9. The collapsible steering column assembly set forth in claim 5 wherein the second surface and the first surface extend in a rearward direction angling toward one-another for causing a reduction in the radius of the bend segment as the column collapses.

10. The collapsible steering column assembly set forth in claim 5 wherein the strap is a loop.

11. The collapsible steering column assembly set forth in claim 10 further comprising:
the bend segment being a first bend segment; and
a second bend segment of the strap opposing the first bend segment, and wherein the first segment extends between ends the first and second bend segments and the second segment extends between opposite ends of the first and second bend segments.

12. The collapsible steering column assembly set forth in claim 11 wherein the first segment is engaged to the inner jacket near the second bend segment and the second segment is engaged to the outer jacket near the first bend segment.

13. The collapsible steering column assembly set forth in claim 3 wherein the strap is folded over upon itself at the first end forming first and second layers of the strap.

14. The collapsible steering column assembly set forth in claim 4 wherein the first and second layers have respective first and second arcuate portions of the bend segment both open in a common direction.

15. A collapsible steering column assembly for a vehicle comprising:
a column extending longitudinally along a centerline in forward and rearward directions, the column having a forward inner jacket and a rearward outer jacket, wherein the inner and outer jackets are constructed and arranged to collapse axially with respect to one another;
a first surface carried by the inner jacket facing radially outward;
a second surface carried by the outer jacket facing radially inward and spaced radially outward from the first surface;
wherein the first and second surfaces extend axially and converge radially in the rearward direction;
a deformable strap being bent over upon itself and having a first segment engaged to the inner jacket and second segment engaged to the outer jacket and a bend segment disposed between the first and second segments and spanning between the first and second surfaces; and
the bend segment having a first radius prior to column collapse and a smaller second radius after column collapse.

16. The collapsible steering column assembly set forth in claim 15 wherein the inner jacket is secured rigidly to the vehicle and the outer jacket is constructed and arranged to move in the forward direction during column collapse.

17. The collapsible steering column assembly set forth in claim 16 wherein the first and second segments project axially in the forward direction and from the bend segment.

18. The collapsible steering column assembly set forth in claim 17 wherein deformation of the strap during column collapse causes the bend segment to generally scroll into the first segment.

19. A method of operating a collapsible steering column assembly comprising the steps of:
exerting a forward directed force by a driver of a vehicle upon the steering column;
telescopically retracting a steering column in an axial direction;
deforming a strap of an energy absorbing device within an axial extending recess in an outer jacket of the steering column;
scrolling a bend segment of the strap along a first segment of the strap engaged to an inner jacket of the column; and
reducing a radius of curvature of the bend segment as the steering column retracts.
